(19) United States
(12) Patent Application Publication
(10) Pub. No.: US 2026/0041536 A1
(43) Pub. Date: Feb. 12, 2026

(54) ORAL CARE DEVICE AND METHOD FOR CONTROLLING ORAL CARE DEVICE

(71) Applicant: Shenzhen Soocas Technology Co., Ltd., Shenzhen (CN)

(72) Inventors: Jinhong ZHAO, Shenzhen (CN); Zhikun YIN, Shenzhen (CN); Fandi MENG, Shenzhen (CN)

(73) Assignee: Shenzhen Soocas Technology Co., Ltd., Shenzhen (CN)

(21) Appl. No.: 18/991,556

(22) Filed: Dec. 22, 2024

Related U.S. Application Data
(63) Continuation of application No. PCT/CN2024/124588, filed on Oct. 12, 2024.

(30) Foreign Application Priority Data
Aug. 6, 2024 (CN) 202411079354.X

(51) Int. Cl. A61C 17/34; A61C 17/22

(52) U.S. Cl. CPC A61C 17/3409; A61C 17/227

(57) ABSTRACT

Embodiments of this specification provide an oral care device and a method for controlling the oral care device. The oral care device includes a main unit, which includes a fluid reservoir, a power component, and a control component. The power component is electrically connected to the control component, and the power component is in fluid communication with a fluid reservoir, and the power component includes an electric motor. The control component is configured to obtain a current voltage value of the electric motor, compare the current voltage value with a preset voltage value of the electric motor in a current operating mode to obtain a comparison result, adjust a current duty cycle according to the comparison result, and carry out voltage control on the oral care device by adjusting the current duty cycle.

### CROSS REFERENCE TO RELATED APPLICATION

This application is a continuation of International Application No. PCT/CN2024/124588, filed on Oct. 12, 2024, which claims priority to Chinese Patent Application No. 202411079354.X, titled “ORAL CARE DEVICE AND METHOD FOR CONTROLLING ORAL CARE DEVICE” and filed to the China National Intellectual Property Administration on Aug. 6, 2024, the entire contents of which are incorporated herein by reference.

### TECHNICAL FIELD

Embodiments of this specification relate to the field of oral care technology, and more particularly, to an oral care device and a method for controlling the oral care device.

### BACKGROUND

At present, when controlling water pressure of oral care devices, voltage may be divided into different levels, with one duty cycle set for each level. When the duty cycle changes, the voltage changes accordingly. Thus, the voltage is controlled by setting the duty cycle, to achieve the objective of stabilizing the water pressure. The duty cycle refers to a ratio, in a periodic signal, of duration of a high level or conducting state to entire cycle time.

However, in the above solutions, as fluctuating data, the voltage causes fluctuation of the water pressure of the oral care devices, which further leads to poor operating stability of the oral care devices. Therefore, there is an urgent need for a highly stable method for controlling the oral care devices.

### SUMMARY

In view of this, embodiments of this specification provide an oral care device. One or more embodiments of this specification simultaneously relate to a method for controlling an oral care device and an apparatus for controlling the oral care device, to solve technical defects in existing technologies.

According to a first aspect of the embodiments in this specification, there is provided an oral care device, which includes a main unit. The main unit includes a fluid reservoir, a power component, and a control component. The power component is electrically connected to the control component, the power component is in fluid communication with the fluid reservoir, and the power component includes an electric motor.

The control component is configured to obtain a current voltage value of the electric motor, compare the current voltage value with a preset voltage value of the electric motor in a current operating mode to obtain a comparison result, adjust a current duty cycle according to the comparison result, and carry out voltage control on the oral care device by adjusting the current duty cycle.

According to a second aspect of the embodiments of this specification, there is provided a method for controlling the oral care device, which is applied to the control component in the oral care device. The oral care device includes the main unit, which includes the fluid reservoir, the power component, and the control component. The power component is electrically connected to the control component, the power component is in fluid communication with the fluid reservoir, and the power component includes the electric motor. The method for controlling the oral care device includes:
obtaining a current voltage value of the electric motor;
comparing the current voltage value with a preset voltage value of the electric motor in a current operating mode to obtain a comparison result;
adjusting a current duty cycle according to the comparison result; and
carrying out voltage control on the oral care device by adjusting the current duty cycle.

According to a third aspect of the embodiments of this specification, there is provided an apparatus for controlling the oral care device, which is applied to the control component in the oral care device. The oral care device includes the main unit, which includes the fluid reservoir, the power component, and the control component. The power component is electrically connected to the control component, the power component is in fluid communication with the fluid reservoir, and the power component includes the electric motor. The apparatus for controlling the oral care device includes:
an obtaining module configured to obtain a current voltage value of the electric motor;
a comparison module configured to compare the current voltage value with a preset voltage value of the electric motor in a current operating mode to obtain a comparison result;
an adjustment module configured to adjust a current duty cycle according to the comparison result; and
a control module configured to carry out voltage control on the oral care device by adjusting the current duty cycle.

The oral care device provided in one embodiment of this specification includes the main unit, which includes the fluid reservoir, the power component, and the control component. The power component is electrically connected to the control component, the power component is in fluid communication with the fluid reservoir, and the power component includes the electric motor. The control component is configured to obtain a current voltage value of the electric motor, compare the current voltage value with a preset voltage value of the electric motor in a current operating mode to obtain a comparison result, adjust a current duty cycle according to the comparison result, and carry out voltage control on the oral care device by adjusting the current duty cycle. By monitoring the current voltage value of the electric motor and adjusting the current duty cycle according to the current voltage value and the preset voltage value of the electric motor in the current operating mode, the control component carries out voltage control on the oral care device, thereby achieving dynamic stability of the voltage of the electric motor, and improving operating stability of the oral care device.

### BRIEF DESCRIPTION OF THE DRAWINGS

FIG. 1 is a schematic structural diagram of an oral care device according to one embodiment of this specification;

FIG. 2 is a flowchart of a method for controlling the oral care device according to one embodiment of this specification;

FIG. 3 is a flowchart of treating processes of the method for controlling the oral care device according to one embodiment of this specification; and

FIG. 4 is a schematic structural diagram of an apparatus for controlling the oral care device according to one embodiment of this specification.

### DETAILED DESCRIPTION

In the following description, many specific details are elaborated to facilitate sufficient understanding of this specification. However, this specification can be implemented in many other ways different than what is described herein, and those skilled in the art may make similar popularizations without violating contents of this specification. Therefore, this specification is not limited by specific implementations disclosed below.

First, terminologies involved in one or more embodiments of this specification are explained.

As a microcomputer system, a micro controller unit (MCU) integrates a central processing unit (CPU), a memory, a timer/counter, multiple input/output interfaces and other peripheral functions on a single chip. In electronic devices and embedded systems, the MCU plays a role of core control, and takes charge of processing data operation, logic control, signal processing, and communication with peripheral devices in the systems. The MCU includes a hardware unit, which can generate a pulse width modulation (PWM) signal, and thus may be referred to as a PWM module.

In voltage stabilization technologies for an oral care device on the market, voltage stabilization is achieved by dividing battery voltage into 10 levels, where each level corresponds to one duty cycle. However, the above voltage stabilization methods are relatively rough. This is because no feedback circuit is provided in the oral care device, an electric motor voltage fluctuates greatly, resulting in unstable fluid pressure inside the oral care device.

To solve the above problems, in the embodiments of this specification, an electric motor voltage feedback circuit is additionally provided in the oral care device to monitor the electric motor voltage, and a current duty cycle is adjusted through a voltage stabilization algorithm to achieve dynamic stability of the electric motor voltage, such that the pressure of the fluid in the oral care device does not suddenly change with the fluctuation of the battery voltage. In this way, operating stability of the oral care device is improved.

In this specification, an oral care device is provided. This specification also relates to a method for controlling the oral care device and an apparatus for controlling the oral care device, and descriptions thereof are to be made detail by detail in the following embodiments.

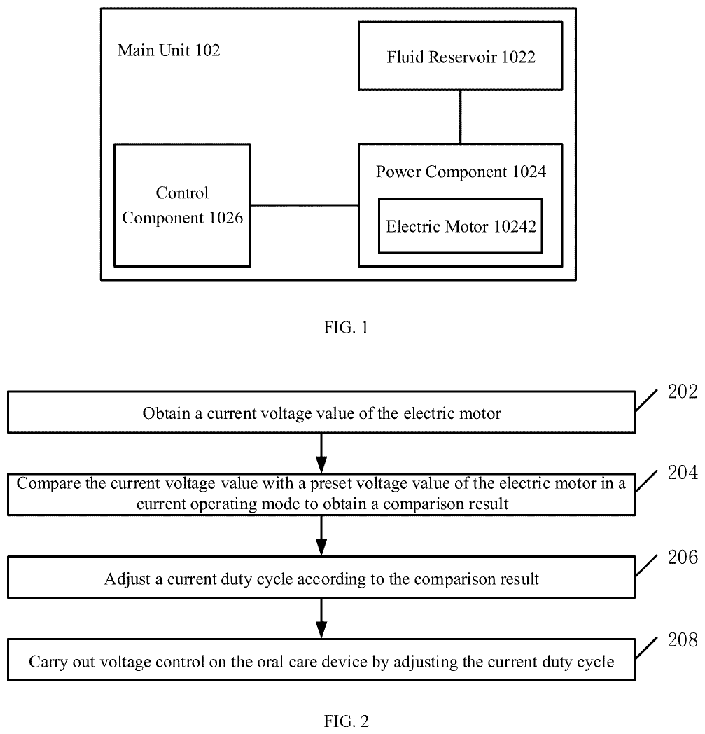

Referring to FIG. 1, FIG. 1 shows a schematic structural diagram of an oral care device according to one embodiment of this specification. The oral care device includes a main unit 102, which includes a fluid reservoir 1022, a power component 1024, and a control component 1026. The power component 1024 is electrically connected to the control component 1026, and the power component 1024 is in fluid communication with the fluid reservoir 1022. The power component 1024 includes an electric motor 10242.

The control component 1026 is configured to obtain a current voltage value of the electric motor 10242, compare the current voltage value with a preset voltage value of the electric motor in a current operating mode to obtain a comparison result, adjust a current duty cycle according to the comparison result, and carry out voltage control on the oral care device by adjusting the current duty cycle.

Specifically, the oral care devices refer to various appliances and tools used for maintaining and promoting oral hygiene, preventing oral diseases, and assisting in oral treatment. Based on their functions, the oral care devices may be classified into different types, such as oral cleaning devices and oral treatment devices. The oral cleaning device includes but is not limited to an electric toothbrush, a mouthwash dispenser, an oral irrigator, and an integrated rinsing device.

The main unit refers to a control unit or power source that serves as a core part of the oral care device. The main unit is used for providing essential energy (such as electric power) and/or control signals to the oral care device, to drive the oral care device to complete corresponding operations. For example, in the electric toothbrush, the main unit is internally equipped with the electric motor and a battery, and sometimes it also includes an intelligent control system. The electric motor drives a brush head to vibrate or rotate, and the battery provides power to the electric motor. The intelligent control system may include a timer, a pressure sensor or the like, to enhance toothbrushing experiences and effects. For another example, in the oral irrigator, the main unit is internally equipped with a fluid reservoir (such as a water tank), a pump, and the battery. The pump extracts a fluid (such as water) from the fluid reservoir and pressurizes it, thereby forming an impact fluid, which can rinse gaps between teeth through a fluid outlet (such as a nozzle).

The fluid reservoir is a container or storage component used for depositing or storing fluids (such as water, mouthwash, cleaning solutions, or other oral care fluids). The fluid reservoir is used for ensuring that a device can continuously provide the fluid on demand during use, to assist in completing various oral cleaning or treatment functions.

The power component can provide essential power sources to the oral care device, to ensure that the oral care device can execute its expected functions such as cleaning or massage. The power component may include an electric motor for driving the fluid and a pump component.

The control component refers to the micro controller unit in the oral care device. The electric motor in the oral care device typically is a small DC motor, which is used to convert electric energy into mechanical energy to drive an internal pump body. For the purpose of portability and wireless use, the oral care device is typically equipped with a built-in power supply (such as a battery or adapter). The battery includes but is not limited to a lithium-ion battery or nickel-hydrogen battery. The battery is used to store the electric energy and provide power to the electric motor and other electronic components (such as control circuits). In an alternative embodiment of this specification, capacity, lifespan, and charging efficiency of the battery are important factors affecting endurance and user experience of the oral care device. As the service life increases, the battery's storage capacity may decrease, and users may replace the battery by themselves or charge it frequently to extend the lifespan of the oral care device. Therefore, the battery may be a replaceable rechargeable battery.

The current voltage value of the electric motor may be referred to as a voltage value of the electric motor. The current voltage value of the electric motor may be determined based on an input voltage value of the power supply and an electric motor negative electrode voltage value of the electric motor. Specifically, an electric motor positive electrode voltage value is equal to the input voltage value of the power supply, and the current voltage value of the electric motor may be obtained by subtracting the electric motor negative electrode voltage value from the input voltage value of the power supply. The current operating mode may be understood as a current operating gear value of the oral care device. The oral care device is equipped with different operating gears, which correspond to different fluid pressures to provide the users with multiple oral care intensities to choose from. The preset voltage value of the electric motor in the current operating mode refers to a voltage value of the electric motor when the oral care device operates in the current operating mode. The preset voltage value is specifically set according to actual situations, and may include a corresponding input voltage and a duty cycle, which is not restricted in the embodiments of this specification.

The comparison result is used for describing whether the current voltage value is greater or smaller than the preset voltage value of the electric motor in the current operating mode. The duty cycle refers to a ratio, in a pulse system that operates periodically, of time when the oral care device is in operation (such as when the electric motor is powered on) to an entire operating cycle. The current duty cycle may be obtained by querying from a configuration file of the oral care device.

It should be noted that according to the comparison result, the process of adjusting the current duty cycle is a dynamic adjustment process. The control component dynamically adjusts the current duty cycle based on the current voltage value and the preset voltage value of the electric motor in the current operating mode to obtain a more suitable target duty cycle, such that the current voltage value tends to the preset voltage value or is adjusted to be the preset voltage value. In this way, the fluid pressure conforms to the preset fluid pressure of the current operating mode. During the dynamic adjustment, the current duty cycle may be adjusted based on a preset deviation range, which may be obtained by means of configuration based on attribute information of the electric motor. The preset deviation range and number of adjustments are specifically set according to the actual situations, which is not restricted in the embodiments of this specification. By adjusting the current duty cycle, energy consumption may be effectively managed, and efficiency of the electric motor may be optimized. Especially when battery level drops, stable operation of the device may be maintained, or when adapter voltage deviates, consistency of the fluid pressure under a set operating mode may be controlled.

Further, the control component can regulate the voltage supplied to the electric motor by adjusting the current duty cycle, to achieve precise control on the entire oral care device. Specifically, the control component may adjust the current duty cycle to be the target duty cycle, and write the target duty cycle into a corresponding register of the control component, to achieve voltage control by configuring the duty cycle. In this way, it may be ensured that the oral care device can work efficiently and stably in different operating modes.

In one possible embodiment of this specification, the current voltage value may be compared with the preset voltage value of the electric motor in the current operating mode to obtain the comparison result. In another possible embodiment of this specification, because the input voltage value of the power supply is constant, the electric motor negative electrode voltage value may be compared with the preset voltage value of the electric motor in the current operating mode to obtain the comparison result.

Using the solutions in the embodiments of this specification, the control component monitors the current voltage value of the electric motor and adjusts the current duty cycle according to the current voltage value and the preset voltage value of the electric motor in the current operating mode, to carry out voltage control on the oral care device, thereby achieving the objective of dynamic voltage balance of the electric motor, and improving the operating stability of the oral care device.

In an alternative embodiment of this specification, the control component is also configured to reduce the current duty cycle when the current voltage value is greater than the preset voltage value, or increase the current duty cycle when the current voltage value is smaller than the preset voltage value.

It should be noted that when the current voltage value is greater than the preset voltage value, the voltage control on the oral care device may be achieved by reducing the current duty cycle. Reducing the current duty cycle means shorting time spent in outputting a high level for the PWM module of the oral care device MCU. In this way, time spent in transmitting energy to load can be shorted, and thus output voltage can be reduced. When the current voltage value is smaller than the preset voltage value, the voltage control on the oral care device may be achieved by increasing the current duty cycle. Increasing the current duty cycle means prolonging the time spent in outputting the high level for the PWM module of the oral care device MCU. In this way, time spent in transmitting the energy to the load can be prolonged, and thus the output voltage can be increased.

According to the solutions in the embodiments of this specification, the current voltage value is compared with the preset voltage value, and the current duty cycle is adjusted according to the comparison result. In this way, efficient voltage control on the oral care device is achieved.

In an alternative embodiment of this specification, the control component is also configured to obtain a current deviation value according to the current voltage value and the preset voltage value, compare the current deviation value with a preset deviation range to obtain a comparison result, and adjust the current duty cycle according to the comparison result.

Specifically, the current deviation value is an absolute value of a difference value between the current voltage value of the electric motor and the preset voltage value. The preset deviation range refers to a deviation range between the preset current voltage value and the preset voltage value. When the deviation range is preset, in one possible embodiment, a deviation upper limit value and a deviation lower limit value may be set, and boundaries of the deviation range may be defined according to the deviation upper limit value and the deviation lower limit value. In another possible embodiment, only the deviation upper limit value may be set, which may be understood as a deviation threshold. In this case, the boundaries of the deviation range are 0 and the deviation upper limit value, respectively. The preset deviation range is selected according to the actual situations, which is not restricted in the embodiments of this specification.

It should be noted that the comparison result obtained by comparing the current deviation value with the preset deviation range may indicate that the current deviation value is within the deviation range, or the current deviation value is greater than the deviation range, or the current deviation value is smaller than the deviation range.

According to the solutions in the embodiments of this specification, the current deviation value is compared with the preset deviation value, and the current duty cycle is adjusted according to the comparison result. In this way, it is implemented that magnitude of increase or decrease in the current duty cycle changes according to variations in the comparison result, thus achieving the objective of dynamic voltage balance.

In an alternative embodiment of this specification, the control component is also configured to adjust the current duty cycle according to a first adjustment value when the current deviation value is within the deviation range.

The control component is also configured to adjust the current duty cycle according to a second adjustment value when the current deviation value is greater than a first threshold of the deviation range.

The first adjustment value is smaller than the second adjustment value.

It should be noted that when the current deviation value is within the deviation range, this indicates that the deviation between the current voltage value and the preset voltage value is smaller. In this case, the current duty cycle may be gradually adjusted with a smaller first adjustment value, to gradually correct the voltage of the oral care device. Furthermore, when the current duty cycle is adjusted, it is gradually adjusted according to the first adjustment value, and the current voltage value is not directly adjusted to be the preset voltage value. In this way, the current voltage value may gradually approach the preset voltage value, thereby avoiding voltage leap.

When the current deviation value is greater than the first threshold of the deviation range, this indicates that the deviation between the current voltage value and the preset voltage value is larger. In this case, the current duty cycle may be gradually adjusted with a larger second adjustment value, to gradually correct the voltage of the oral care device. In this way, it is avoidable that consumption of longer time is required to correct the voltage of the oral care device with the smaller first adjustment value, thereby improving efficiency of voltage dynamic balance. Furthermore, when the current duty cycle is adjusted, it is gradually adjusted according to the second adjustment value, and the current voltage value is not directly adjusted to be the preset voltage value. In this way, the current voltage value may gradually approach the preset voltage value, thereby avoiding the voltage leap. Response or change speed is faster when the difference between the electric motor voltage and a target voltage is larger; and the change is precise or stable when the difference is smaller. The first threshold may be the deviation upper limit value.

When the current deviation value is smaller than the deviation range, in one possible embodiment, the current duty cycle may be adjusted, such that the current voltage value approaches the preset voltage value. In another possible embodiment, when the current deviation value is smaller than a second threshold of the deviation range, this indicates that the current deviation value is so small that the current voltage value is very close to the preset voltage value, and the current deviation value is within an allowable deviation range. In this case, the current duty cycle may not be adjusted to avoid a problem of decrease in power conversion efficiency caused by frequent voltage adjustment. That is, the control component is also configured to not adjust the current duty cycle when the current deviation value is smaller than the second threshold of the deviation range. The second threshold is specifically set according to the actual situations, which is not restricted in the embodiments of this specification. The second threshold may be the deviation lower limit value.

For example, assuming the preset voltage value is 9.1V, the current voltage value of the electric motor is 2V, and the voltage change of the electric motor is triggered every x milliseconds, x is specifically set according to the actual situations. Based on the current voltage value 2V and the preset voltage value 9.1V, the current deviation value may be determined to be 7.1V, which obviously is greater than the first threshold 2V of the deviation range. In this case, the current voltage value may be gradually adjusted according to the larger second adjustment value 1V. When the current voltage value increases to 8V in units of 1V, the current deviation value may be determined to be 1.1V according to the current voltage value 8V and the preset voltage value 9.1V. Apparently, the current deviation value 1.1V is within the deviation range 0.2V-2V. In this case, the current voltage value 8V may be gradually adjusted according to the smaller first adjustment value 0.2V. When the current voltage value increases from 8V to 9V in units of 0.2V, the current deviation value may be determined to be 0.1V according to the current voltage value 9V and the preset voltage value 9.1V. Apparently, the current deviation value 0.1V is smaller than the second threshold 0.2V. Therefore, the current voltage value is not further adjusted.

In an alternative embodiment of this specification, the control component is also configured to obtain a first difference value when the current voltage value is determined to be greater than the preset voltage value according to the comparison result, where the first difference value is obtained by subtracting the preset voltage value from the current voltage value.

The control component is also configured to obtain a target duty cycle when the first difference value is greater than the first threshold, where the target duty cycle is obtained by subtracting the second adjustment value from the current duty cycle. The control component is also configured to obtain a target duty cycle when the first difference value is smaller than the first threshold, where the target duty cycle is obtained by subtracting the first adjustment value from the current duty cycle.

It should be noted that the first difference value is equal to the current voltage value minus the preset voltage value when the current voltage value is greater than the preset voltage value. After the first difference value is obtained, it is determined a size relationship between the first difference value and the first threshold. The first threshold is set according to the actual situations, which is not restricted in the embodiments of this specification. When the first difference value is greater than the first threshold, the current duty cycle is reduced by a larger amplitude which is larger than a decreasing amplitude where the first difference value is smaller than the first threshold. When the first difference value is smaller than the first threshold, the current duty cycle is reduced by a smaller amplitude which is smaller than a decreasing amplitude where the first difference value is greater than the first threshold. The specific adjustment range of the current duty cycle is selected according to the actual situations, which is not restricted in the embodiments of this specification. For example, when the first difference value is greater than the first threshold, the target duty cycle may be obtained by subtracting the second adjustment value from the current duty cycle, such that it is controlled to adjust the current duty cycle to be the target duty cycle, thereby adjusting the current voltage value to be the target voltage value. When the first difference value is smaller than the first threshold, the target duty cycle may be obtained by subtracting the first adjustment value from the current duty cycle, such that it is controlled to adjust the current duty cycle to be the target duty cycle, thereby adjusting the current voltage value to be the target voltage value.

In practical applications, when the first difference value is equal to the first threshold, the target duty cycle may be obtained by subtracting the second adjustment value from the current duty cycle, such that it is controlled to adjust the current duty cycle to be the target duty cycle, thereby adjusting the current voltage value to be the target voltage value. Alternatively, the target duty cycle may be obtained by subtracting the first adjustment value from the current duty cycle, such that it is controlled to adjust the current duty cycle to be the target duty cycle, thereby adjusting the current voltage value to be the target voltage value. The specific selection is made according to the actual situations, which is not restricted in the embodiments of this specification.

Using the solutions in the embodiments of this specification, it is determined whether the first difference value is greater than the first threshold, and variation of the duty cycle is controlled according to a determination result. When the first difference value is greater than the first threshold, amplitude of the variation is larger when the current duty cycle is adjusted. When the first difference value is smaller than the first threshold, the amplitude of the variation is smaller when the current duty cycle is adjusted. In this way, quick response may be ensured when the first difference value is greater, and stable operation may be maintained when the first difference value is smaller, making the adjustment of the current duty cycle more flexible and accurate.

In an alternative embodiment of this specification, the control component is also configured to obtain a second difference value when the current voltage value is determined to be smaller than the preset voltage value according to the comparison result, where the second difference value is obtained by subtracting the current voltage value from the preset voltage value.

The control component is also configured to obtain a target duty cycle when the second difference value is greater than the first threshold, where the target duty cycle is obtained by adding the second adjustment value to the current duty cycle. The control component is also configured to obtain the target duty cycle when the second difference value is smaller than the first threshold, where the target duty cycle is obtained by adding the first adjustment value to the current duty cycle.

It should be noted that when the current voltage value is smaller than the preset voltage value, the second difference value is equal to the preset voltage value minus the current voltage value. After the second difference value is obtained, it may be determined a size relationship between the second difference value and the first threshold. The first threshold is set according to the actual situations, which is not restricted in the embodiments of this specification. When the second difference value is greater than the first threshold, the current duty cycle is increased by a larger amplitude which is larger than an increasing amplitude where the second difference value is smaller than the first threshold. When the second difference value is smaller than the first threshold, the current duty cycle is increased by a smaller amplitude which is smaller than an increasing amplitude where the second difference value is greater than the first threshold. The specific adjustment range of the current duty cycle is selected according to the actual situations, which is not restricted in the embodiments of this specification. For example, when the second difference value is greater than the first threshold, the target duty cycle may be obtained by adding the second adjustment value to the current duty cycle, such that it is controlled to adjust the current duty cycle to be the target duty cycle, thereby adjusting the current voltage value to be the target voltage value. When the second difference value is smaller than the first threshold, the target duty cycle may be obtained by adding the first adjustment value to the current duty cycle, such that it is controlled to adjust the current duty cycle to be the target duty cycle, thereby adjusting the current voltage value to be the target voltage value.

In practical applications, when the second difference value is equal to the first threshold, the target duty cycle may be obtained by adding the second adjustment value to the current duty cycle, such that it is controlled to adjust the current duty cycle to be the target duty cycle, thereby adjusting the current voltage value to be the target voltage value. Alternatively, the target duty cycle may be obtained by adding the first adjustment value to the current duty cycle, such that it is controlled to adjust the current duty cycle to be the target duty cycle, thereby adjusting the current voltage value to be the target voltage value. The specific selection is made according to the actual situations, which is not restricted in the embodiments of this specification.

Using the solutions in the embodiments of this specification, it is determined whether the second difference value is greater than the first threshold, and variation of the duty cycle is controlled according to a determination result. Amplitude of the variation of the current duty cycle is larger when the second difference value is greater than the first threshold. The amplitude of the variation of the current duty cycle is smaller when the second difference value is smaller than the first threshold. In this way, quick response may be ensured when the second difference value is greater, and stable operation may be maintained when the second difference value is smaller, making the adjustment of the current duty cycle more flexible and accurate.

In an alternative embodiment of this specification, the power component is configured to provide power to transport a fluid from the fluid reservoir to a fluid outlet, and the control component is also configured to control a voltage of the power component.

Furthermore, the power component is also configured to control a pressure of the fluid flowing out of the oral care device based on the voltage control, such that the pressure conforms to the current operating mode of the oral care device.

It should be noted that after receiving a voltage control signal sent by the control component, the power component may control the pressure of the fluid flowing out of the fluid reservoir, such that the fluid flows out of the fluid outlet of the oral care device with different impact intensities (power). Generally, the pressure of the fluid is directly proportional to the preset voltage value of the electric motor in the current operating mode. For example, the greater the preset voltage value of the electric motor in the current operating mode is, the greater the pressure of the fluid is, and the greater the impact strength of the fluid flowing out is.

Using the solutions in the embodiments of this specification, the control component sends the voltage control signal to the power component, such that the power component controls the pressure of the fluid based on the voltage control signal, thereby achieving dynamic control of the fluid pressure based on the current operating mode of the oral care device, making the operation of the oral care device more stable and controllable.

In an alternative embodiment of this specification, the control component is also configured to obtain an electric motor voltage sampling condition, where the electric motor voltage sampling condition includes at least one of: a state of the electric motor being in a starting state, sampling duration satisfying a preset duration threshold, a state of the main unit being in an operating state, and a sampling state being in sampling. When the electric motor satisfies the electric motor voltage sampling condition, the control component samples the voltage of the electric motor for many times to obtain the current voltage value of the electric motor.

It should be noted that the state of the electric motor includes an off state and the starting state. The state of the main unit includes an operating state and a non-operating state. The sampling state includes sampling and pausing sampling, where the pausing sampling may be understood as in data processing. The preset duration threshold is set according to the actual situations, such as 1 millisecond, which is not restricted in the embodiments of this specification. Methods for sampling motor voltage include, but are not limited to, analog-to-digital conversion sampling (ADC), integrated Hall effect sensor sampling and differential amplifier sampling, and are selected according to the actual situations, which is not restricted in the embodiments of this specification.

In practical applications, when the electric motor satisfies the electric motor voltage sampling condition, the voltage of the electric motor may be sampled for many times to obtain a plurality of voltage values of the electric motor. The current voltage value of the electric motor may be obtained by averaging the plurality of voltage values of the electric motor. For example, when a handle is removed from the main unit, the main unit is awaken by means of Hall, and the main unit is turned on by means of a short press on an on-off key. After the main unit is turned on, it may sample the battery voltage every other second. Once the electric motor starts operating, a timed task of electric motor voltage sampling may be initiated, and this task may be executed every 1 millisecond. In the task, the electric motor voltage may be sampled once, one average value may be calculated every 10 electric motor voltages are sampled, and one current voltage value of the electric motor may be calculated out on a basis of every 10 average values. Meanwhile, the sampling in the task may be paused, and the sampling is not restarted until data processing is completed.

Using the solutions in the embodiments of this specification, only when the electric motor meets the electric motor voltage sampling condition, the electric motor voltage is sampled for many times to obtain the current voltage value of the electric motor. In this way, the electric motor voltage sampling is not performed when the electric motor voltage sampling condition is not satisfied, which reduces resource waste, and improves efficiency of the electric motor voltage sampling.

In an alternative embodiment of this specification, the oral care device also includes a power supply, and the electric motor is electrically connected to the power supply. The control component is also configured to obtain an electric motor negative electrode voltage value of the electric motor. The current voltage value of the electric motor can be obtained according to an input voltage value of the power supply and the electric motor negative electrode voltage value.

In practical applications, there are various ways for the control component to obtain the electric motor negative electrode voltage value of the electric motor, and a selection may be made according to the actual situations, which is not restricted in the embodiments of this specification. In one possible embodiment of this specification, the control component may obtain the electric motor negative electrode voltage value by means of direct sampling. In some cases, the control component is unable to obtain the electric motor negative electrode voltage value by means of sampling. Therefore, In another possible embodiment of this specification, the electric motor voltage sampling condition may be first obtained before the sampling. When the electric motor satisfies the electric motor voltage sampling condition, the electric motor negative electrode voltage value is obtained by means of sampling.

It should be noted that the input voltage of the power supply refers to a power supply voltage supplied to the electric motor, such as the battery voltage. The input voltage of the power supply may affect energy that can be obtained by the electric motor. The electric motor negative electrode voltage may reflect the operating state of the electric motor. After the target duty cycle is obtained, the timed sampling task may be restarted to resample the electric motor negative electrode voltage value, and this cycle is repeated.

In an alternative embodiment of this specification, the control component is also configured to sample the electric motor voltage for many times when the electric motor satisfies the electric motor voltage sampling condition, to obtain a plurality of first voltage sampling values and a first sampling count value, where a sampling count value is obtained based on superposition of sampling times. When the first sampling count value reaches a first preset value, the first sampling count value is reset to zero, and a second voltage sampling value and a second sampling count value is determined according to the plurality of first voltage sampling values, where the second sampling count value is obtained based on superposition of reset times. It is returned to the step of sampling the electric motor voltage for many times to obtain the plurality of first voltage sampling values and the first sampling count value until the second sampling count value reaches a second preset value. In this case, the electric motor negative electrode voltage value is determined according to a plurality of second voltage sampling values, and the sampling state is adjusted to the pausing sampling.

It should be noted that the method for sampling the electric motor voltage for many times may also be divided into two phases as below. In the first phase, after the electric motor voltage sampling task is initiated, an electric motor voltage sampling function may be called every Ims, and this function can implement electric motor voltage sampling and electric motor voltage averaging. After the electric motor sampling function is entered, when the state of the electric motor is in the starting state, the sampling duration satisfies the preset duration threshold, the state of the main unit is in the operating state, and the sampling state is in sampling, the electric motor voltage is sampled by means of the ADC, to obtain a first voltage sampling value and a first sampling count value (starting from 1 and adding 1 each time). It is returned the step of calling the electric motor voltage sampling function every Ims. When the first sampling count value reaches the first preset value (such as 10), the first sampling count value is reset to zero, to enter the second phase. In the second phase, the 10 first voltage sampling values obtained in the first phase are averaged to obtain the second voltage sampling value and the second sampling count value (starting from 1 and adding 1 each time). When the second sampling count value reaches the second preset threshold (such as 10), the second sampling count value is reset to zero, and the 10 second voltage sampling values are averaged to obtain the electric motor negative electrode voltage value. Finally, the sampling state is switched to pausing sampling, to stop sampling the electric motor voltage, and it is started to adjust the current duty cycle according to the battery voltage value and the electric motor negative electrode voltage value, to obtain the target duty cycle.

Using the solutions in the embodiments of this specification, the electric motor voltage sampling in the above two phases ensures the electric motor negative electrode voltage value to be more accurate, laying a foundation for the subsequent adjustment of the current duty cycle.

Referring to FIG. 2, FIG. 2 shows a flowchart of a method for controlling the oral care device according to one embodiment of this specification. The method for controlling the oral care device is applied to a control component in the oral care device. The oral care device includes a main unit, which includes a fluid reservoir, a power component, and the control component. The power component is electrically connected to the control component, the power component is in fluid communication with the fluid reservoir, and the power component includes an electric motor. The method for controlling the oral care device includes following steps.

In Step 202, a current voltage value of the electric motor is obtained.

In Step 204, the current voltage value is compared with a preset voltage value of the electric motor in a current operating mode, to obtain a comparison result.

In Step 206, a current duty cycle is adjusted according to the comparison result.

In Step 208, voltage control is carried out on the oral care device by adjusting the current duty cycle.

It should be noted that implementations of Steps 202 to 208 are the same as workflows of the control component in the above oral care device, and thus detailed descriptions thereof are not to be repeated in the embodiments of this specification.

Using the solutions in the embodiments of this specification, the current voltage value of the electric motor is monitored, and the current duty cycle is adjusted according to the current voltage value and the preset voltage value of the electric motor in the current operating mode, to carry out voltage control on the oral care device, thereby achieving the objective of dynamic voltage balance of the electric motor, and improving the operating stability of the oral care device.

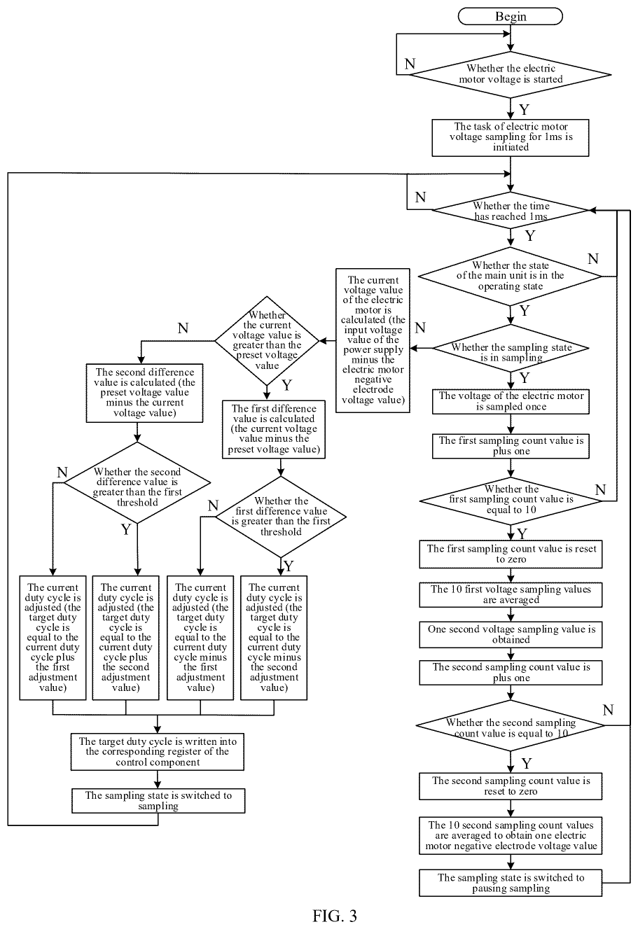

Referring to FIG. 3, FIG. 3 shows a flowchart of treating processes of the method for controlling the oral care device according to one embodiment of this specification, including a sampling phase and a data processing phase.

In the sampling phase, when it is started to control the oral care device, because running the electric motor in the same operating mode has different time, it may be determined whether the electric motor has been started. It is further determined whether the electric motor has been started when a determination result is No. The task of electric motor voltage sampling for 1 ms is initiated when the determination result is YES. After the task of electric motor voltage sampling for Ims is initiated, it is determined whether time has reached Ims. It is further determined whether the time has reached Ims when a determination result is No. It is determined whether the state of the main unit is in the operating state when the determination result is YES. It is further determined whether the time has reached Ims when a determination result is No. It is determined whether the sampling state is in sampling when the determination result is YES. A step of “calculating a voltage value of the electric motor” in the data processing phase is entered when a determination result is No. The voltage of the electric motor is sampled once to obtain the first voltage sampling value when the determination result is YES, and the first sampling count value is plus one. After the first sampling count value is plus one, it is determined whether the first sampling count value is equal to 10. It is further determined whether the time has reached 1 ms when a determination result is No. The first sampling count value is reset to zero when the determination result is YES, the 10 first voltage sampling values are averaged to obtain one second voltage sampling value, and the second sampling count value is plus one. After the second sampling count value is plus one, it is determined whether the second sampling count value is equal to 10. It is further determined whether the time has reached Ims when a determination result is No. The second sampling count value is reset to zero when the determination result is YES, and the 10 second sampling count values are averaged to obtain one electric motor negative electrode voltage value. Finally, the sampling state is switched to pausing sampling, and it is further determined whether the time has reached 1 ms.

In the data processing phase, the current voltage value of the electric motor is calculated, the current voltage value of the electric motor is equal to the input voltage value of the power supply minus the electric motor negative electrode voltage value, and it is determined whether the current voltage value is greater than the preset voltage value, the preset voltage value is the preset voltage value of the electric motor in the current operating mode. The first difference value is calculated, the first difference value is equal to the current voltage value minus the preset voltage value, when a determination result is YES. The second difference value is calculated, the second difference value is equal to the preset voltage value minus the current voltage value, when the determination result is NO. After the first difference value is calculated, it is determined whether the first difference value is greater than the first threshold. The current duty cycle is adjusted when a determination result is YES, the target duty cycle is equal to the current duty cycle minus the second adjustment value. The current duty cycle is adjusted when the determination result is NO, the target duty cycle is equal to the current duty cycle minus the first adjustment value, where the first adjustment value is smaller than the second adjustment value. After the second difference value is calculated, it is determined whether the second difference value is greater than the first threshold. The current duty cycle is adjusted when a determination result is YES, the target duty cycle is equal to the current duty cycle plus the second adjustment value. The current duty cycle is adjusted when the determination result is NO, the target duty cycle is equal to the current duty cycle plus the first adjustment value. After the target duty cycle is obtained by adjusting the current duty cycle, the target duty cycle may be written into the corresponding register of the control component, and the sampling state is switched to sampling, and then it is further determined whether the time has reached 1 ms.

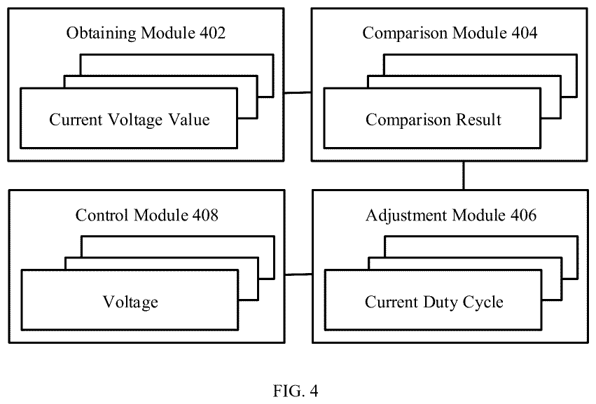

Corresponding to the above method embodiments, this specification also provides embodiments of the apparatus for controlling the oral care device. FIG. 4 shows a schematic structural diagram of the apparatus for controlling the oral care device according to one embodiment of this specification. As shown in FIG. 4, the apparatus is applied to the control component in the oral care device. The oral care device includes a main unit, which includes a fluid reservoir, a power component, and a control component. The power component is electrically connected to the control component, the power component is in fluid communication with the fluid reservoir, and the power component includes an electric motor. The apparatus for controlling the oral care device includes:

an obtaining module 402 configured to obtain a current voltage value of the electric motor;
a comparison module 404 configured to compare the current voltage value with a preset voltage value of the electric motor in a current operating mode to obtain a comparison result;
an adjustment module 406 configured to adjust a current duty cycle according to the comparison result; and
a control module 408 configured to carry out voltage control on the oral care device by adjusting the current duty cycle.

Using the solutions in the embodiments of this specification, the control component monitors the current voltage value of the electric motor and adjusts the current duty cycle according to the current voltage value and the preset voltage value of the electric motor in the current operating mode, to carry out voltage control on the oral care device, thereby achieving dynamic voltage balance of the electric motor, and improving the operating stability of the oral care device.

The above is a schematic solution of the apparatus for controlling the oral care device in this embodiment. It should be noted that the technical solutions of the apparatus for controlling the oral care device belong to the same concept as the technical solutions of the method for controlling the oral care device. Thus, reference may be made to the description of the technical solutions of the method for controlling the oral care device for details of the technical solutions of the apparatus for controlling the oral care device, which are not described in detail.

What is claimed is:

1. An oral care device comprising a main unit, the main unit comprising a fluid reservoir, a power component, and a control component, wherein the power component is electrically connected to the control component, the power component is in fluid communication with the fluid reservoir, and the power component comprises an electric motor; and
the control component is configured to obtain a current voltage value of the electric motor, compare the current voltage value with a preset voltage value of the electric motor in a current operating mode to obtain a comparison result, adjust a current duty cycle according to the comparison result, and carry out voltage control on the oral care device by adjusting the current duty cycle.

2. The oral care device according to claim 1, wherein the control component is further configured to reduce the current duty cycle when the current voltage value is greater than the preset voltage value, or increase the current duty cycle when the current voltage value is smaller than the preset voltage value.

3. The oral care device according to claim 1, wherein the control component is further configured to obtain a current deviation value according to the current voltage value and the preset voltage value, compare the current deviation value with a preset deviation range to obtain a comparison result, and adjust the current duty cycle according to the comparison result.

4. The oral care device according to claim 3, wherein the control component is further configured to adjust the current duty cycle according to a first adjustment value when the current deviation value is within the deviation range; and/or
the control component is further configured to adjust the current duty cycle according to a second adjustment value when the current deviation value is greater than a first threshold of the deviation range; and
the first adjustment value is smaller than the second adjustment value.

5. The oral care device according to claim 4, wherein the control component is further configured to obtain a first difference value when the current voltage value is determined to be greater than the preset voltage value according to the comparison result, the first difference value being obtained by subtracting the preset voltage value from the current voltage value; and
the control component is further configured to obtain a target duty cycle when the first difference value is greater than the first threshold, the target duty cycle being obtained by subtracting the second adjustment value from the current duty cycle; and the control component is further configured to obtain the target duty cycle when the first difference value is smaller than the first threshold, the target duty cycle being obtained by subtracting the first adjustment value from the current duty cycle.

6. The oral care device according to claim 4, wherein the control component is further configured to obtain a second difference value when the current voltage value is determined to be smaller than the preset voltage value according to the comparison result, the second difference value being obtained by subtracting the current voltage value from the preset voltage value; and
the control component is further configured to obtain a target duty cycle when the second difference value is greater than the first threshold, the target duty cycle being obtained by adding the second adjustment value to the current duty cycle; and the control component is further configured to obtain the target duty cycle when the second difference value is smaller than the first threshold, the target duty cycle being obtained by adding the first adjustment value to the current duty cycle.

7. The oral care device according to claim 3, wherein the control component is further configured to not adjust the current duty cycle when the current deviation value is smaller than a second threshold of the deviation range.

8. The oral care device according to claim 1, wherein the power component is configured to provide power to transport a fluid from the fluid reservoir to a fluid outlet; and the control component is further configured to control a voltage of the power component; and
the power component is further configured to control a pressure of the fluid flowing out of the oral care device based on the voltage control, such that the pressure conforms to the current operating mode of the oral care device.

9. The oral care device according to claim 1, wherein the control component is further configured to obtain an electric motor voltage sampling condition, the electric motor voltage sampling condition comprising at least one of: a state of the electric motor being in a starting state, sampling duration satisfying a preset duration threshold, a state of the main unit being in an operating state, and a sampling state being in sampling; when the electric motor satisfies the electric motor voltage sampling condition, the control component is further configured to sample the voltage of the electric motor for many times to obtain the current voltage value of the electric motor.

10. The oral care device according to claim 1, wherein the oral care device further comprises a power supply, the electric motor is electrically connected to the power supply, and the control component is further configured to obtain an electric motor negative electrode voltage value of the electric motor, and obtain the current voltage value of the electric motor according to an input voltage value of the power supply and the electric motor negative electrode voltage value.

11. A method for controlling an oral care device being applied to a control component in the oral care device, the oral care device comprising a main unit, wherein the main unit comprises a fluid reservoir, a power component, and the control component, the power component being electrically connected to the control component, the power component being in fluid communication with the fluid reservoir, and the power component comprising an electric motor;
and the method for controlling the oral care device comprises:
obtaining a current voltage value of the electric motor;
comparing the current voltage value with a preset voltage value of the electric motor in a current operating mode to obtain a comparison result;
adjusting a current duty cycle according to the comparison result; and
carrying out voltage control on the oral care device by adjusting the current duty cycle.

12. The method for controlling the oral care device according to claim 11, further comprises: reducing the current duty cycle when the current voltage value is greater than the preset voltage value, or increasing the current duty cycle when the current voltage value is smaller than the preset voltage value.

13. The method for controlling the oral care device according to claim 11, further comprises: obtaining a current deviation value according to the current voltage value and the preset voltage value, comparing the current deviation value with a preset deviation range to obtain a comparison result, and adjusting the current duty cycle according to the comparison result.

14. The method for controlling the oral care device according to claim 13, further comprises: adjusting the current duty cycle according to a first adjustment value when the current deviation value is within the deviation range; and/or
adjusting the current duty cycle according to a second adjustment value when the current deviation value is greater than a first threshold of the deviation range; and
the first adjustment value is smaller than the second adjustment value.

15. The method for controlling the oral care device according to claim 14, further comprises: obtaining a first difference value when the current voltage value is determined to be greater than the preset voltage value according to the comparison result, the first difference value being obtained by subtracting the preset voltage value from the current voltage value; and
obtaining a target duty cycle when the first difference value is greater than the first threshold, the target duty cycle being obtained by subtracting the second adjustment value from the current duty cycle; and obtaining the target duty cycle when the first difference value is smaller than the first threshold, the target duty cycle being obtained by subtracting the first adjustment value from the current duty cycle.

16. The method for controlling the oral care device according to claim 14, further comprises: obtaining a second difference value when the current voltage value is determined to be smaller than the preset voltage value according to the comparison result, the second difference value being obtained by subtracting the current voltage value from the preset voltage value; and
obtaining a target duty cycle when the second difference value is greater than the first threshold, the target duty cycle being obtained by adding the second adjustment value to the current duty cycle; and obtain the target duty cycle when the second difference value is smaller than the first threshold, the target duty cycle being obtained by adding the first adjustment value to the current duty cycle.

17. The method for controlling the oral care device according to claim 13, further comprises: not adjusting the current duty cycle when the current deviation value is smaller than a second threshold of the deviation range.
